(19) United States
(12) Patent Application Publication
(10) Pub. No.: US 2010/0299207 A1
(43) Pub. Date: Nov. 25, 2010

(54) DYNAMIC SYSTEM AND METHOD FOR PASSENGER INTERACTIVE EXCHANGE

(76) Inventors: Amos Harlev, Kfar Truman (IL); Ofer Kelman, Har Adar (IL)

Correspondence Address: DANIEL J SWIRSKY, 55 REUVEN ST., BEIT SHEMESH, 99544, IL

(21) Appl. No.: 12/732,221

(22) Filed: Mar. 26, 2010

Related U.S. Application Data
(60) Provisional application No. 61/164,437, filed on Mar. 29, 2009.

(51) Int. Cl. G06Q 30/00

(52) U.S. Cl. 705/14.62

(57) ABSTRACT

An on-board dynamic and interactive information and exchange system and method enabling passengers while traveling in transportation vehicles to acquire services from selective vendors located at intended destinations merging the purchase power of an individual customer into the purchase power of a group of customers. It also can merge in real time the purchasing powers of said groups of passengers in a plurality of vehicles traveling towards same destinations at given time intervals into a common network forming an even greater purchasing group. It also enables passengers to receive prices and deals at changing terms as getting closer to destination, and vendors to gain ‘captive audience’ prospective customers at concrete times.

### FIELD OF THE INVENTION

The present invention generally relates to distance oriented dynamic exchange and entertainment systems, and it more particularly relates to the relations between passengers in moving vehicles and prospective vendors.

### BACKGROUND OF THE INVENTION

People travel. Air, land and sea vehicles such as aircraft, trains, buses and ships carry millions of passengers annually. The passengers of those vehicles usually consume various services offered on board such as food & beverage, purchasing, entertainment, information and communication. For providing these services many of the vehicles are equipped with suitable tangible and intangible means and systems and may also employ professional personnel such as cabin attendants. There exist many types and forms of means and systems to avail services to passengers. A typical traditional one is the airline brochure distributed to passengers in the aircraft cabin which contains information on food and beverage offered on board, movies shown, information about the airline routes and travel destinations, duty free items and gifts offered for sale on board and advertisements of vendors promoting their business or offering their goods and services. Some commercial passenger vehicles maintain other means to service the passengers such as audio programs, video programs, games, telephone communication and recently internet access which enables passengers to browse the web for information, entertainment, on line purchasing and payment and send and receive messages while traveling.

The internet has become a worldwide channel of communication offering versatile possibilities and obtaining substantial portion of conventional communication, information flow and business. Specifically, the internet enables people to receive information on places, services and products, make orders and purchases and even pay online by credit cards or through secured financial clearing entities. In many fields of trade the internet has become a common avenue for conducting business, some of which did not exist before. For example, the internet enables a direct contact between global vendors and global retail customers wherein an individual private buyer in New York can browse the internet searching for jewelry, view online catalogs with photographs, prices and features of necklaces, order a selected necklace from a goldsmith who happens to be located in Paris, pay for it online through a clearing house in London and receive it later by post, thereby eliminating in this case the role of the traditional wholesaler or local distributor. Internet vendors may offer their goods and services for on line sale and bidding granting prospective buyers special terms. For example, vendors can advertise discount prices for a limited number of items until sold out, or put items for price bidding limited by date and time.

Numerous means and methods of providing communication and delivering entertainment and services to individual passengers in a multi-passenger vehicle are known. They may be internal cabin, between cabin and the outside world, and combination thereto. Some transmit passenger requests to cabin attendants with the goal of reducing work load of the attendants. Other means are known to alert cabin attendants to passenger needs. Still other known means and methods deliver entertainment programs to each seat of a multi-passenger vehicle, with the passenger selecting the specific program desired.

Other systems have been disclosed including a satellite receiver for live television broadcasts, providing weather information to passengers or information about the route and destinations.

However the travel related information is not interactive with regard to vendor passenger trade relations.

However the advertising material is substantially predetermined with regard to the real time travel interval.

The various provisions available to passengers in commercial vehicles such as mentioned hereinabove cover on board products and services and on line and off line information, and there is a need for developing and introducing new services and systems for traveling passengers.

### SUMMARY OF THE INVENTION

People on travel require information regarding their destinations such as accommodation, transportation, dining, shopping, entertainment and other services and products available at the destination. Some people who don't plan and book ahead of time before travel will find it advantageous to have short notice ordering and purchasing possibilities on board. An exemplary on board dynamic and interactive information and exchange system and method is described herein below enabling passengers while traveling in transportation vehicles to acquire products and services from selected vendors located at intended destinations merging the purchase power of individual customers into a bigger purchase power of a group of customers. It also can merge in real time the purchasing powers of said groups of passengers in a plurality of vehicles traveling towards same destinations at given time intervals into a common network forming an even greater demand group. The system also enables passengers to receive prices and deals at changing terms as they get closer to destination. The participating vendors and the transportation carriers and operators enjoy the advantage of a selective and focused communication and purchasing network with identified customers who require specific products and services at given concrete time frames. In addition, the system enables the creation of virtual communities among the traveling passengers for share of common interests socially and professionally, common interests at the destination, communication, dating, etc.

In accordance with the present exemplary, a system of computers, servers, communication and payment means, interactive information flow and commercial undertakings for providing products and services to passengers on transport vehicles comprises 1) at least one transport vehicle having a plurality of member terminals or computers or passenger laptops or accesses to cabin server used by the passengers onboard the transport vehicle to communicate, access information and request and acquire services, 2) a computer server called also a cabin server onboard the vehicle for storing data, performing computations and calculations, and acting as a communications gateway to other members in the network used to connect between the passengers terminals and also connect with a central station outside the vehicle, 3) a geographic information system (GIS) which captures, stores, analyzes, manages, and presents data that refers to or is linked to location, and specifically to determine the position of the traveling vehicle in real time, 4) a communications link to a ground based main router outside the vehicle, 5) a ground based router for access to the internet and other members of the network, 6) a central station for providing, controlling, operating and managing the services offered in the system, and 8) at least one vendor computer and communication provisions.

As indicated hereinabove, the transport vehicles can be any of air, land and sea vehicles such as aircraft, trains, buses and ships. A typical prospective customer in the network is a passenger who is interested to make a booking or a purchase while on board traveling towards a known destination and expected to reach that destination in certain time frame, for example to reserve a hotel room, rent a car, buy concert tickets, order secretarial services, hire tour guide, shop, etc. A plurality of such passengers seeking similar products forms a purchasing group with a particular demand. A typical vendor participating in the system can be a hotel located in the destination receiving on line information of the potential demand for rooms at known arrival time frames and quote prices accordingly, or if it needs to fill in vacancies, it can offer improved deals to last minute callers.

### BRIEF DESCRIPTION OF THE DRAWINGS

The invention is herein described, by way of example only, with reference to the accompanying drawings, wherein:

FIG. 1 schematically illustrates the major components of the present invention.

FIG. 2 schematically illustrates the communication network connecting the participants.

FIG. 3 schematically illustrates another embodiment of the communication network connecting the participants.

FIG. 4 schematically illustrates an exemplary of communication among traveling vehicles.

FIG. 5 schematically illustrates vehicle communication architecture.

FIG. 6 schematically illustrates system communication architecture.

FIGS. 7-9 schematically illustrate information flow charts.

### DETAILED DESCRIPTION OF THE INVENTION

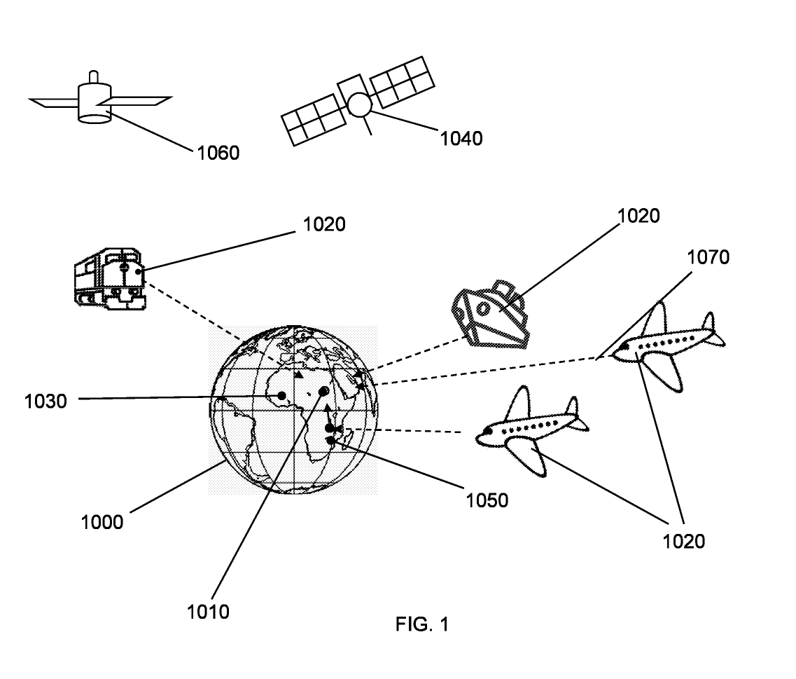

FIG. 1 schematically illustrates a system for providing on-board interactive trade services for passengers in accordance with an embodiment of the present invention. The system is a network positioned on and above the globe 1000 comprising D number of destinations 1010 which may be locations or travel stations or points, each destination having B number of vendors, V number of vehicles 1020 traveling from various sources to known destinations, each vehicle carrying P number of passengers, wherein D, B, V, P≧1. The system also comprises at least one central station 1030 for providing, controlling and managing the services offered in the disclosed system and at least a GPS satellite 1040 and GPS receivers installed on each of the vehicles 1020 and communication channels between the central station 1030 and the participating vendors in destinations 1010 and vehicles 1020 which may comprise of air to ground communication station(s) 1050 and or communication satellite(s) 1060, or their combinations.

The Global Positioning System (GPS) is a global navigation satellite system (GNSS). It uses a constellation of artificial satellites in space that transmit signals, which allow GPS receivers installed on mobile platforms to determine their current location, the time, and their directional velocity. A communications satellite is an artificial satellite positioned in space for the purposes of telecommunications. Point-to-point telecommunications generally refers to a connection restricted to two endpoints, such as host computers, distinct from point-to-multipoint providing multiple paths from a single location to multiple locations which also refers to broadcast or downlink. Communications satellites are also used for mobile applications such as communications to ships, vehicles, planes and hand-held terminals, and for TV and radio broadcasting, for which application of other technologies, such as cable, is impractical or impossible.

It should be appreciated that some destinations may have several ports of entry for passenger vehicles such as airport(s), a harbor, and train and bus station(s). Smaller and remote destinations usually have less arrivals of passenger vehicles than bigger, major or central destinations and the latter may receive many arrivals at a given time interval, such for example as tens of aircraft landings in most hours of the day in the several New York city airports.

The total number of passengers traveling to a destination at given time interval is the cumulative number of passengers P in all the vehicles V which travel to that destination in said time interval. For practical purposes the time intervals are measured in hours because they relate to common travel times between destinations which are usually measured in hours, like for example train travels between cities or aircraft flights between countries. At any given time t each vehicle is positioned at distance d from the destination as illustrated in 1070 which together with its surface or ground velocity determines the expected arrival time to destination.

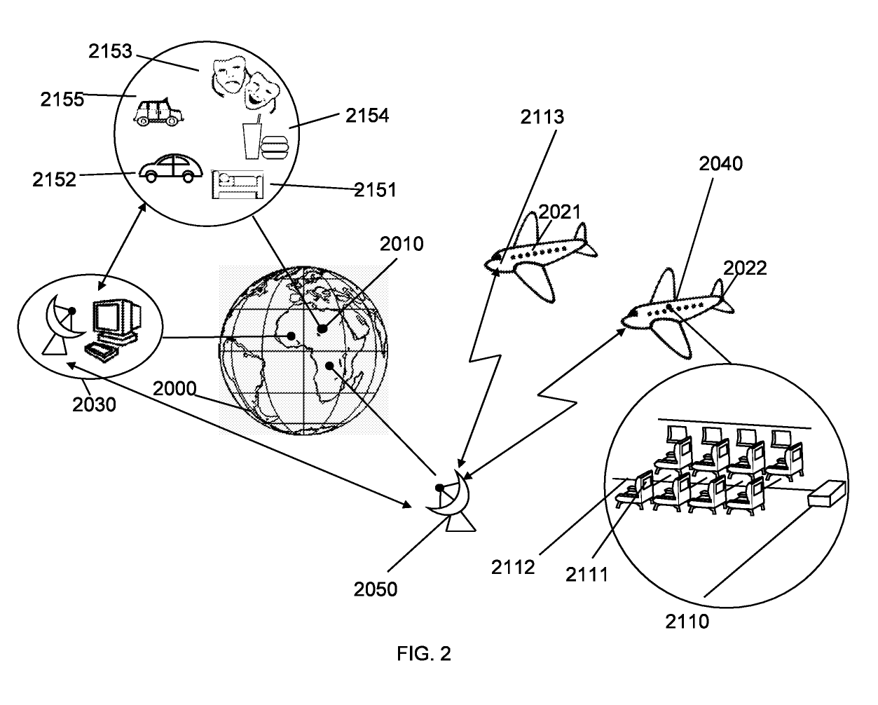

FIG. 2 schematically illustrates a preferred embodiment of communication network of the present invention comprising transportation vehicles 2021 and 2022 traveling towards destination 2010 where various vendors such as hotel 2151, car rental 2152, theater tickets office 2153, restaurant 2154 and taxi service 2155 exist. There may be as many vendors offering various products and services as required by the system managers, including more than a single vendor from each service or business category. It should be appreciated that the term vendor as mentioned in the present invention means any person or party who can offer anything of some kind of value to passengers and the term purchase means the acquiring by passengers of anything for a fee or not for fee. The vendors are connected to the central station preferably through internet connection but other means of communication such as point to point, point to multipoint, wired, wireless or other proprietary communication method may also exist. The illustrated vehicles, which for sake of example only are aircrafts but can be other types of vehicles or combination of various types of vehicles, communicate with the central station through an air/ground station. The central station consists of a computer system and software and a port which can communicate with the vendors, the vehicles and any other member of the system network by similar to the above mentioned communication means. The software enables the operators of the system to identify needs received from passengers, qualify and quantify them into potential purchase interests or purchasing groups and deliver the information to the appropriate vendors. Since the information on the requests and interests of the passengers received from the vehicles is coupled with knowing their location through the GPS, hence knowing their distances from destination and estimated arrival times, the computation abilities of the system can provide the vendors with the size and time request of the potential interests or purchases. For example, if 12 out of the passengers of vehicle 2021 and 17 out of the passengers of vehicle 2022 inquire about car rental in destination 2010, and vehicle 2021 is expected to arrive to destination at 6:30 PM and vehicle 2022 is expected to arrive to destination at 4:15 PM, then the car rental vendors at the destination 2010 who were selected to participate in the system of the present invention can be informed about an expected need for 29 cars within said time interval of same day and prepare accordingly such as making attractive offers in order to close deals with the passengers while still on board before they land and are exposed to competition. It should be appreciated that the communication in the network is dynamic and can occur continuously or at instances during travel time wherein the passengers substantially through the power of the purchasing group can request further information, negotiate and receive improved terms from vendors as they approach destination. Alternatively, some passengers may want to close deals early as possible if they expect shortage in supply at destination such as hotel rooms during a convention week.

Each of the vehicles 2021 and 2022 consists of a cabin server 2110, passenger computer stations or passenger terminals 2111, GPS 2040 and internal communication means 2112 and external communication means 2113 which enable the passengers to participate in the system of the present invention. The communication with the central station 2030 is achieved via a ground/air communication station 2050. The cabin server 2110 controls and supervises the information to and from the passengers and enables them to selectively receive inputs on the destination and its vendors who participate in the system, and collect and further transmit to the central computer on ground the data pertaining to the passengers requests and interests and the data pertaining to the vehicle including its position, hence distance from destination. It should be appreciated that the system controls the nature and amount of information, the communication means and its flow characteristics so that the passengers and vendors are exposed only to what the system management deems appropriate and effective. The passenger terminals 2111 may be individual or shared by plurality of passengers, depends on the architecture and sophistication of the vehicle.

In another advantageous embodiment not illustrated herein the cabin server 2110 also includes at least one computerized work-station used by passengers for communication and purchasing thus replacing the need for personal terminals 2111. The work stations which are installed at convenient places inside the vehicle enable passengers to access the system individually keeping their personal identities same as with using the personal terminals.

It should be emphasized that the interactive exchange system of the present invention as described hereinabove can incorporate also features and elements from other traveling vehicles and passenger oriented entertainment and service systems or be combined with them fully or partially. For example, in parallel to exposing the participating vendors as described hereinabove, the vehicle operators or the system managers can avail internet and email access to passengers wherein they are able to freely communicate with the outside world including other vendors and service providers. The system can also include, compute, be incorporated with and manage information on passengers, travel possibilities, destinations, services and entertainment such as frequent flyer profiles, food and beverage preferences, sight seeing, travel route real time images, on board films and music, and amenity requests from a passenger seat. Also, it can provide information to passengers relating to the aircraft flight and position, and information relating to passenger's connecting flights, maintain and record inventories and passenger requests organized by seat location, supervise passenger games, on board sale of gifts and other features which assist the cabin crew to service the passengers. The available services can be free or for a fee fully or partially with provisions to pay on board.

It should be appreciated that besides connecting the participating vendors to the identified interested passengers as described herein, in another preferred embodiment of the invention the system can enable vendors to promote, advertise and make offers also to other passengers in the vehicle who did not show initial interest or inquire about the specific product or service, however they may become potential customers if exposed to the vendor's message while approaching the destination. The system can also advantageously use its acquired data base on passengers and their behavior and requirements by availing it to vendors who can focus and approach specific passengers. For example, passengers who played with an interactive game can be approached by interactive game vendors in the destination or be exposed to suitable advertising. Similarly, passengers who ordered vegetarian food on board can be approached by vegetarian restaurants in destination.

Furthermore it should be appreciated that the inherent data base and information accumulated in the system, and particularly with regard to passengers, can be an asset disclosed to other vendors who would like to acquire ad-hoc focused on-line distance and destination oriented information and approach the relevant passengers accordingly by placing advertisements and banners or offer deals. The information collected can be also used for understanding and analyzing patterns and behaviors and thereby offered to interested parties off-line as well.

In another preferred embodiment of the present invention the system can function without using GPS whereby the distance related information is not determined in real time but calculated based on predetermined travel schedules with departure times, hence expected arrival times.

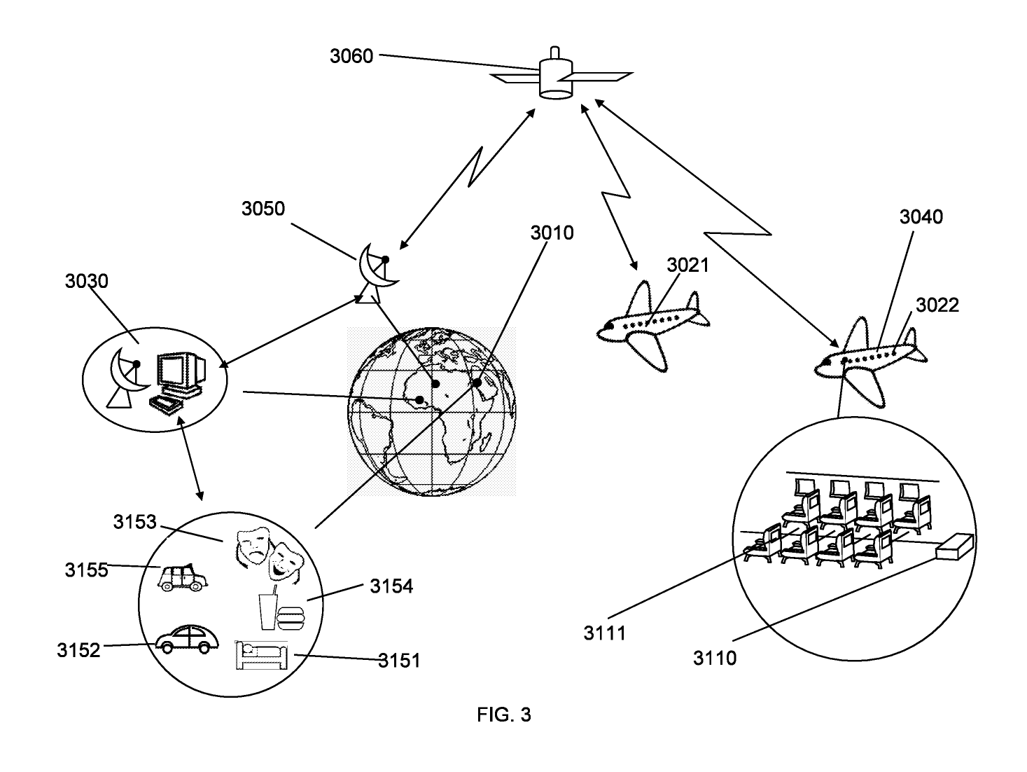

FIG. 3 schematically illustrates another preferred embodiment of communication network of the present invention similar to the one illustrated in FIG. 2, however the connection between the vehicles 3021 and 3022 and the central station 3030 involves also a communication satellite 3060 which connects to a ground station 3050 which then connects to the central station.

It should be restated that the number of vehicles, passengers, destinations and vendors as illustrated in FIG. 2 and FIG. 3 are for sake of example only but in a preferred embodiment of the invention they can be any number≧1 as explained in FIG. 1 hereinabove. Furthermore, the bigger the number of vehicles with their passengers arriving to a destination at a given time frame the bigger the potential benefit for the participating vendors, and respectively the bigger the number of destinations and corresponding number of vendors the bigger the potential benefit for the system owners or operators.

In one another preferred arrangement the communication system is a blend of the systems illustrated in FIG. 2 and FIG. 3 involving both ground and satellite communication media. It is especially applicable in longer distance travel where in some portion of the route the communication is made via satellite and in another portion it is made via ground connection, or in cases where portion of the vehicles use ground communication and others use satellite one, or their combinations.

In another preferred embodiment of the present invention not shown in the figures herein the passengers can communicate substantially directly with the vendors and not necessarily using the communication channel through the central station however, unlike in a typical internet communication, the vendor here is advised of the identity and information of the passenger as participant member in the system by an encoded internet protocol or the like, thus with the built in computer software of the system, the vendors and the passengers can perform similarly to the performance as disclosed in this invention hereinabove.

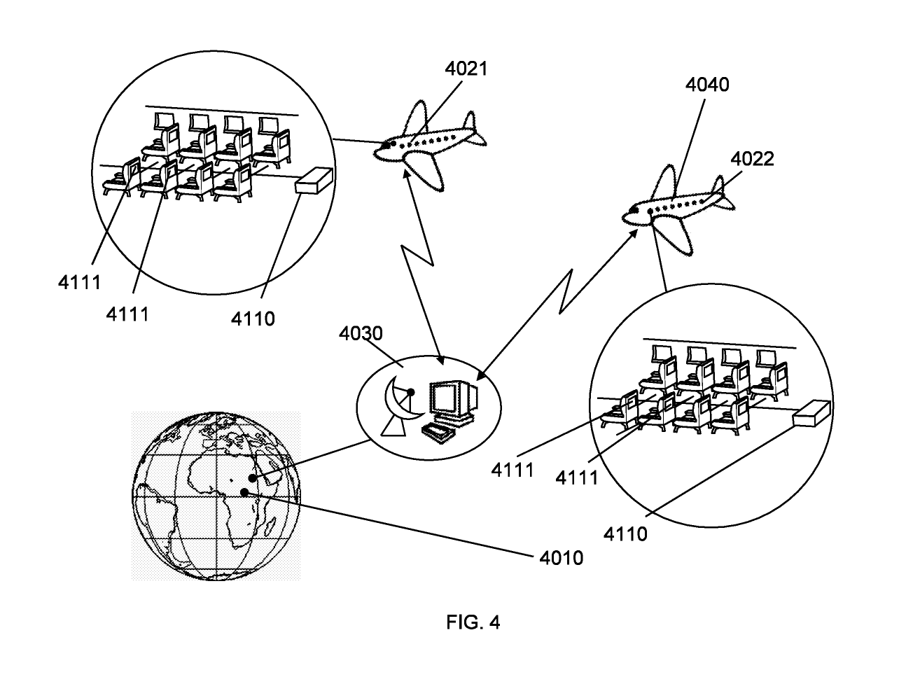

FIG. 4. schematically illustrates an exemplary of interaction between a plurality of vehicles traveling to the same destination. For sake of simplicity FIG. 4. illustrates only two vehicles but there may be more vehicles participating in the system network. Vehicles 4021 and 4022 are traveling to destination 4010 and are at different distances from it and communicate between themselves via the central station 4030, each cabin servers 4110 and their communication means thereby utilizing the functions and advantages of the present invention as described hereinabove and particularly the sharing between vehicles, interactive connections between their passengers via their passenger terminals 4111 and enhancing the purchase power of their passengers. It should be appreciated that the system also enables passengers to communicate among themselves internally in the vehicles and not only with passengers of other vehicles or with other external to the vehicle members of the network. The distance hence time to destination of vehicle 4022 is determined by using GPS 4040 and the time to destination of vehicle 4021 is determined by published travel schedules and time tables.

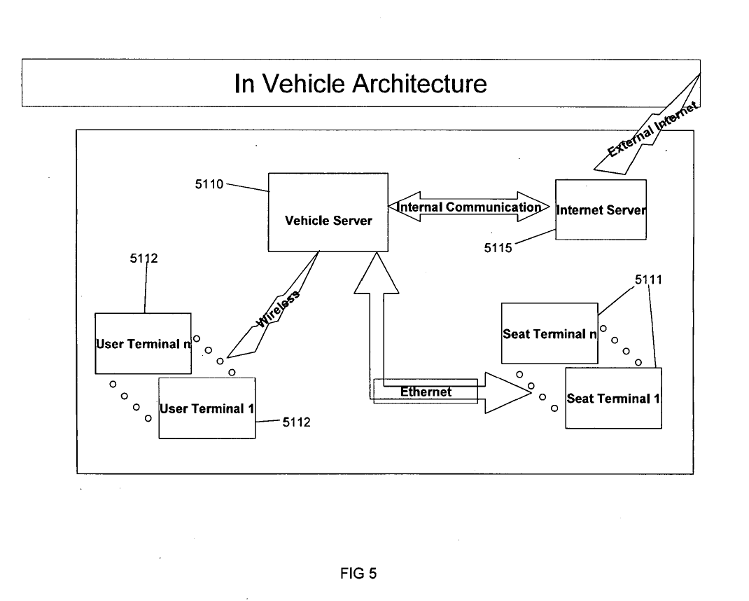

FIG. 5. is a schematic block diagram of one of the preferred embodiments of the inside vehicle system architecture of the present invention wherein the passengers are linked to the cabin server 5110 via seat or local terminals 5111 by Ethernet connection or also via users terminals such as laptop computers, smart phones or other personal communication devices 5112 by wireless connection also named Wi-Fi. Ethernet is a system for connecting and coordinating the components of a local area network which is a computer network within a relatively limited area or within a common environment, as one within office, building, or one connecting offices on separate floors. The cabin server 5110 is connected to the rest of the system, namely the outside of the vehicle, by an internet server 5115 which communicates with the outside web via wireless external internet provisions.

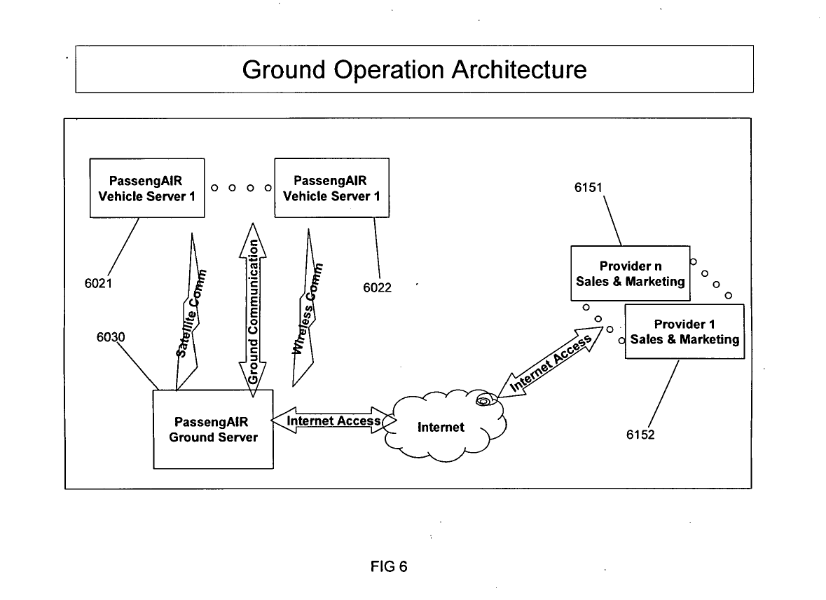

FIG. 6. is a schematic block diagram of one of the preferred embodiments of the outside the vehicle system architecture of the present invention wherein vehicles 6021 and 6022 are connected to the central station 6030 through satellite communication, ground communication or wireless communication whereas the vendors, also called providers, 6151 and 6152 connect to the central station via internet access.

It should be appreciated that there are other preferred embodiments besides those illustrated in the above mentioned FIGS. 1 through 6 which are not shown herein consisting of a plurality of central stations which may be independent governing their own networks, such as regional or specialized networks, or linked to a main central station which becomes the headquarters of the system. Also it should be appreciated that the communication unit and the computer unit of the central station may not be physically in the same location.

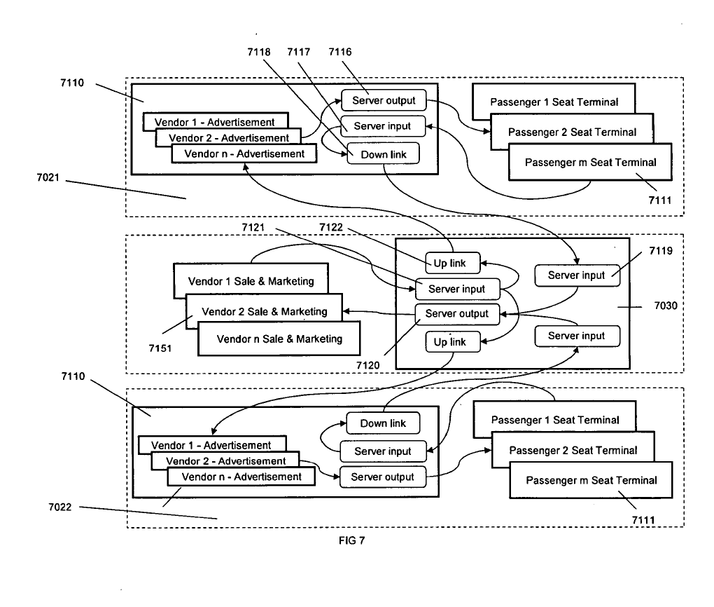

FIGS. 7-9 are schematic flow charts of information in an exemplary preferred embodiment of the present disclosure. FIG. 7 illustrates a central station 7030, n number of vendors 7151 wherein n≧1, two vehicles 7021 and 7022 having m passenger terminals 7111 wherein m≧1 and cabin servers 7110. The system provides the participating vendors with initial information on arriving vehicles at certain time schedules, and the vendors can upload their advertisements into the cabin server which then transfers them to the passenger terminals via output 7116. The exposure of passengers to the advertisements and to other destination and vendor related information made available by the system create initial purchasing interests by some of them expressed as computer ‘clicks’ or other communication signals which are transmitted back to the cabin server via input 7117 and then further transmitted to the central server 7030 using downlink 7118 and input 7119. The central server processes the information received from vehicle 7021 together with information received similarly from vehicle 7022 and advises the selected vendors via output 7120 about the relevant passengers interests including their time to destination, thus establishing a real time dialog between passengers and vendors.

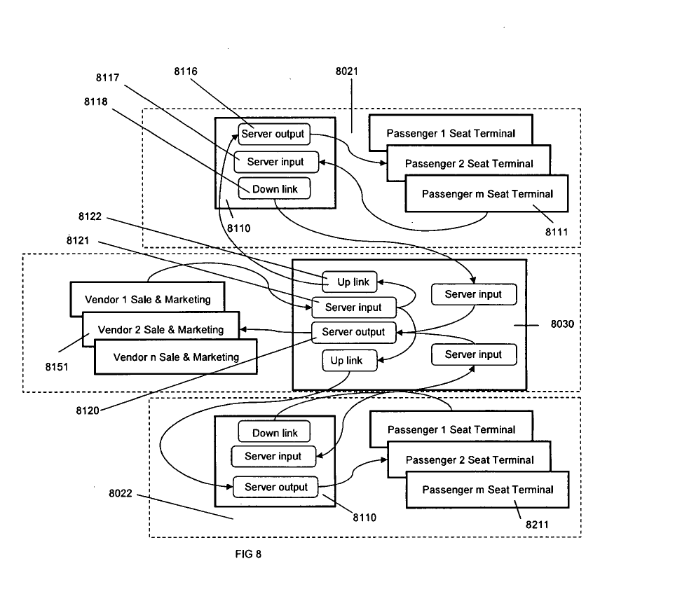

FIG. 8 illustrates the response of the relevant vendors to the initial purchasing interests received from passengers expressed in form of sending proposals and focused information to the corresponding passengers using input 8121 of the central server which processes it and transfers it to the passengers via uplink 8122 and cabin server output 8116. The passengers can accept or reject the proposals or request further information or improved terms via input 8117, downlink 8118 and central server output 8120. It should be appreciated that the dialog between passengers and vendors is dynamic and may continue during the travel time enabling them to reach a purchase order or another conclusive action towards arrival of the vehicle to destination.

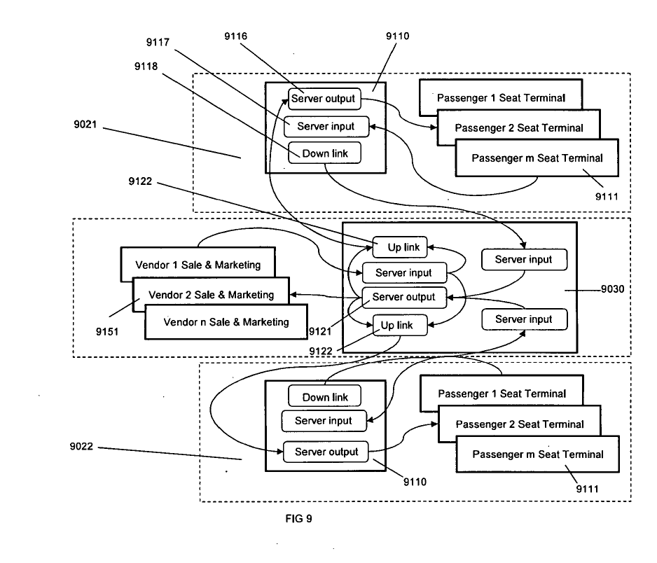

FIG. 9 illustrates the possibility of the system to connect between passengers of different vehicles for purposes of personal communication and exchange of information or with respect to the destination and its vendors. This enables the communicating passengers to co-ordinate their positions and respond as a group to the vendors' proposals. The passengers can use available communication channels via vehicle server inputs 9117 and outputs 9116 and central station output 9121 and uplink 9122. It should be appreciated that the connecting between passengers of different vehicles is in addition to the possibility to connect between passengers of the same vehicle via the cabin server.

While the invention has been described above particularly with respect to commercial traveling vehicles, it will be appreciated that the invention, or various aspects of the invention as described above, may also be advantageously used with non commercial and military vehicles on missions.

Accordingly, while the invention has been described with respect to several preferred embodiments, it will be understood that these are set forth merely for purposes of example, and that many other variations, modifications and applications of the invention may be made within the scope of the claims.

What is claimed is:

1. A network system for exchanging information and providing products and services to passengers on board transportation vehicles, the system comprising:
at least one passenger transportation vehicle traveling to destination comprising:
at least one passenger computerized access terminal,
at least one computer server connected with the passengers terminals and also with a central station outside the vehicle,
a geographic positioning device able to determine the global position of the vehicle in real time;
communication link connecting the vehicle to other elements of the network;
a router with access to the internet and to other elements of the network,
a central station for processing the data and operating the services offered by the system;
at least one vendor with computer and communication provisions at the vehicle's destination,
wherein said information system enables passengers traveling in transportation vehicles to be exposed to selective information from participating vendors and acquire products and services from said vendors offered at destinations, merging on line the purchase power of individual customers into enhanced purchase power of a group of customers, wherein the total potential customer group consists of the number of interested passengers of each vehicle multiplied by the number of vehicles planned to arrive at destination at substantially the same time frame.

2. The system of claim 1 wherein the system enables the creation of on line communities among the traveling passengers for share of information and common interests.

3. The system of claim 1 wherein the passengers through their terminals access the internet and on board entertainment and information.

4. The system of claim 1 wherein the vehicle is either of an aircraft, a train, vessel, and bus.

5. The system of claim 1 wherein the system comprises of two way vehicle to central station and central station to vehicle communication.

6. The system of claim 1 wherein passengers negotiate and are offered improved terms from vendors on line as they approach destination.

7. The system of claim 1 wherein there are multitude of central stations for either of individual destinations and cluster of destinations.

8. The system of claim 1 wherein the passengers' terminals may be either of personal computers, telephones and personal electronic widget.

9. The system of claim 1 wherein the passengers communicate on line directly with the vendors.

10. The system of claim 1 wherein communication is achieved either of via satellite, ground stations and their combination.

11. The system of claim 6 wherein the increase in number of interested passengers as the vehicle approaches destination further improve the terms offered by vendors.

12. The system of claim 1 wherein information is exchanged with passengers also off board the vehicle.

13. A method for connecting between passengers while on board transportation vehicles and selected vendors offering products and services at the destinations of the vehicles, the connection being interactive and on line network enabling the passengers to acquire products and services at improved terms and the vendors to acquire focused on board customers due to arrive to destination at known time frame, the method comprising:
recruiting selected vendors offering their goods and services at destinations enjoying the benefit of focused customers with identified needs to be fulfilled after arrival to destination;
exposing the passengers of vehicles to information and offers provided by the selected vendors members of the network;
establishing and managing an on line communication network connecting interactively between said vendors and passengers utilizing the purchase power of multiple passengers traveling at same time interval to same destination and requiring there substantially the same products and services; and
using facilities, equipment, processing and communication means to enable effective operation of said network.

14. The method of claim 13 wherein the vehicle is an aircraft.

15. The method of claim 13 wherein the passengers use the internet and other web and communication means.

16. The method of claim 13 wherein the communication between vendors and passengers comprises bidding and change of terms as the vehicle gets closer to destination.

17. The method of claim 13 wherein the passengers in the network communicate directly among themselves and establish networking and social connections.

18. The method of claim 13 wherein the communication is verbal.
